(19) United States
(12) Patent Application Publication
(10) Pub. No.: US 2013/0314010 A1
(43) Pub. Date: Nov. 28, 2013

(54) FAN ROTATION SPEED CONTROL SYSTEM

(71) Applicants: HONG FU JIN PRECISION INDUSTRY (WUHAN) CO., LTD., (US); HON HAI PRECISION INDUSTRY CO., LTD., New Taipei (TW)

(72) Inventors: ZHI-YONG GAO, Wuhan (CN); TING-TING WU, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/832,650

(22) Filed: Mar. 15, 2013

(30) Foreign Application Priority Data
May 25, 2012 (CN) 201210165266.2

(51) Int. Cl. H02P 7/24

(52) U.S. Cl. CPC H02P 7/245
USPC 318/400.06

(57) ABSTRACT

An exemplary fan rotation speed control system for adjusting rotation speed of a fan includes a switch input module, a rotation speed control module, a signal collecting module, a decoding module, and a display module. The switch input module inputs a rotation speed signal in the rotation speed control module. The rotation speed control module outputs a first direct current (DC) voltage to provide power supply for the fan according to the rotation speed signal. The rotation speed control module adjusts values and directions of the first DC voltage according to the rotation speed signal. The signal collecting module collects rotation information of the fan. The rotation speed control module receives the rotation information and decodes the rotation information to rotation speed values by the decoding module which are displayed on the display module.

### BACKGROUND

1. Technical Field

The present disclosure relates to systems for controlling the rotation speed of a fan.

2. Description of Related Art

Using pulse-width modulation (PWM) to control the rotation speed of a cooling fan is an established method for reducing the cost of a variable speed fan in a cooling system. PWM signals can vary the operating speeds of the cooling fan since the rotation speed of the fan is determined by the duty cycle. For example, a PWM signal having a duty cycle of 100 percent makes the fan run at maximum. Whereas, a PWM signal having a duty cycle of 50 percent makes the fan run at a rate approximately half speed. However, due to manufacturing limitations, fans made according to a same specification might have different rotation speeds under the same duty cycle, even if the same manufacturer produces the fans. It may be hard to precisely control different fans in different computer systems via a same control mode.

Therefore there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an embodiment of a fan rotation speed control system; the fan rotation speed control system includes a switch input module, a rotation speed control module, a signal collecting module, a decoding module, and a display module.

FIG. 2 is a circuit view of one embodiment of the switch input module, the rotation speed control module, and two fans of FIG. 1.

FIG. 3 is a circuit view of the signal collecting module of FIG. 1.

FIG. 4 is a circuit view of the decoding module and the display module of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

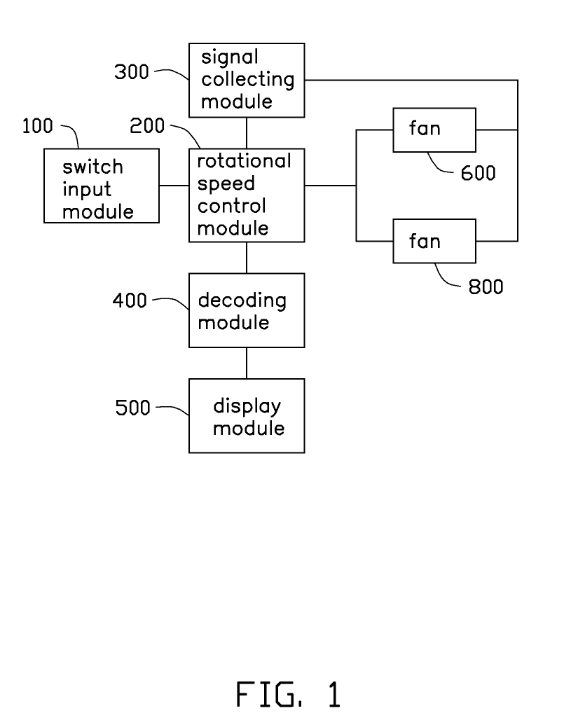

FIG. 1 illustrates a block view of an embodiment of a fan rotation speed control system for adjusting rotation speed of fans 600 and 800, in accordance with one embodiment. The system includes a switch input module 100, a rotation speed control module 200, a signal collecting module 300, a decoding module 400, and a display module 500. The switch input module 100 inputs a rotation speed signal in the rotation speed control module 200. The rotation speed control module 200 outputs a first direct current (DC) voltage to provide power supply for the fans 600 and 800 accordingly. The rotation speed control module 200 adjusts values and directions of the first DC voltage according to the rotation speed signal. The signal collecting module 300 collects rotation information of the fans 600 and 800. The rotation speed control module 200 receives the rotation information, and decodes the rotation information to rotation speed values by the decoding module 400 which are displayed on the display module 500.

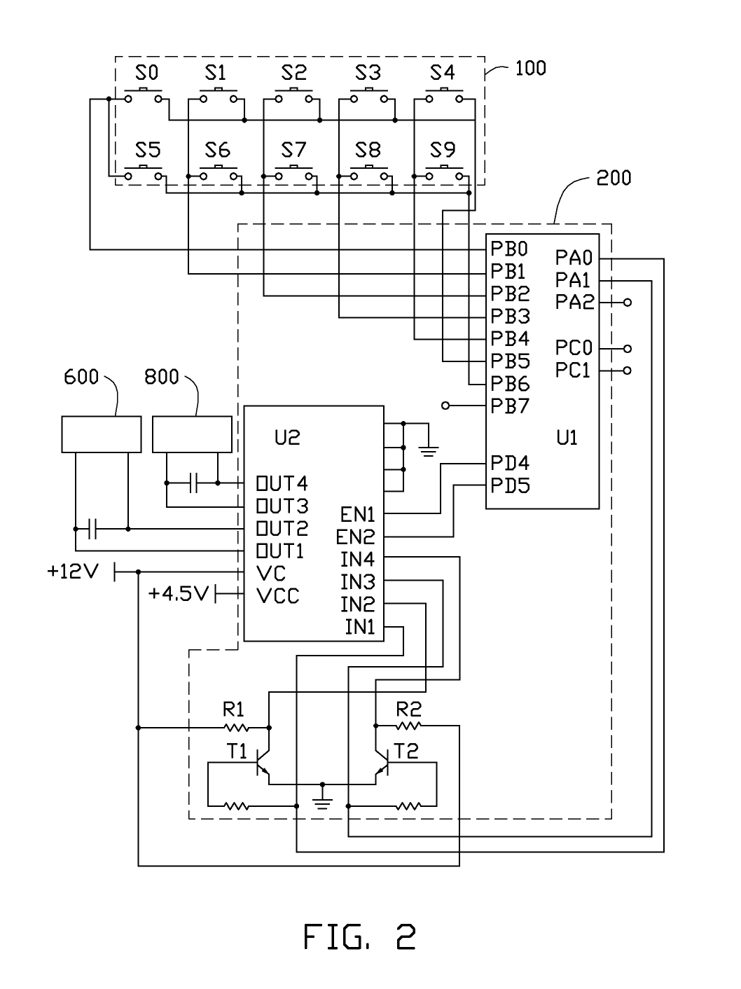

FIG. 2 illustrates a circuit view of the switch input module 100, the rotation speed control module 200, and the fans 600 and 800, in accordance with one embodiment. The switch input module 100 includes a plurality of push buttons S0-S9. The rotation speed control module 200 includes a micro controller U1, a rotation speed controller chip U2, a first transistor T1, a second transistor T2, a first resistor R1, and a second resistor R2. The micro controller U1 includes a first control signal output terminal PA0, a second control signal output terminal PA1, a rotation speed fine tuning input terminal PA3, a plurality of rotation speed input terminals PB0-PB6, a rotation information input terminal PB7, a serial data output terminal PC0, a clock signal output terminal PC1, a first pulse signal output terminal PD0, and a second pulse signal output terminal PD1. The rotation speed controller chip U2 includes a first pulse signal input terminal EN1, a second pulse signal input terminal EN2, a first voltage output terminal OUT1, a second voltage output terminal OUT2, a third voltage output terminal OUT3, a fourth voltage output terminal OUT4, a first control signal input terminal IN1, a second control signal input terminal IN2, a third control signal input terminal IN3, and a fourth control signal input terminal IN4.

First terminals of the push switches S0 and S5 are electrically connected to the rotation speed input terminal PB0. First terminals of the push switches S1 and S6 are electrically connected to the rotation speed input terminal PB1. First terminals of the push switches S2 and S7 are electrically connected to the rotation speed input terminal PB2. First terminals of the push switches S3 and S8 are electrically connected to the rotation speed input terminal PB3. First terminals of the push switches S4 and S9 are electrically connected to the rotation speed input terminal PB4. Second terminals of the push switches S0-S4 are electrically connected to the rotation speed input terminal PB5. Second terminals of the push switches S5-S9 are electrically connected to the rotation speed input terminal PB6. The first pulse signal output terminal PD0 and the second pulse signal output terminal PD1 are electrically connected to the first pulse signal input terminal EN1 and the second pulse signal input terminal EN2 respectively.

The first control signal output terminal PA0 is electrically connected to the first control signal input terminal IN1. The first control signal output terminal PA0 is electrically connected to a base of the first transistor T1. An emitter of the first transistor T1 is grounded. A collector of the first transistor T1 receives a second DC voltage via the first resistor R1. The collector of the first transistor T1 is electrically connected to the second control signal input terminal IN2.

The second control signal output terminal PA1 is electrically connected to the third control signal input terminal IN3. The second control signal output terminal PA1 is electrically connected to a base of the second transistor T2. An emitter of the second transistor T2 is grounded. A collector of the second transistor T2 receives the second DC voltage via the second resistor R2. The collector of the second transistor T2 is electrically connected to the fourth control signal input terminal IN4. The first voltage output terminal OUT1 and the second voltage output terminal OUT2 are electrically connected to the fan 600. The third voltage output terminal OUT3 and the fourth voltage output terminal OUT4 are electrically connected to the fan 800. In one embodiment, the second DC voltage is +12V.

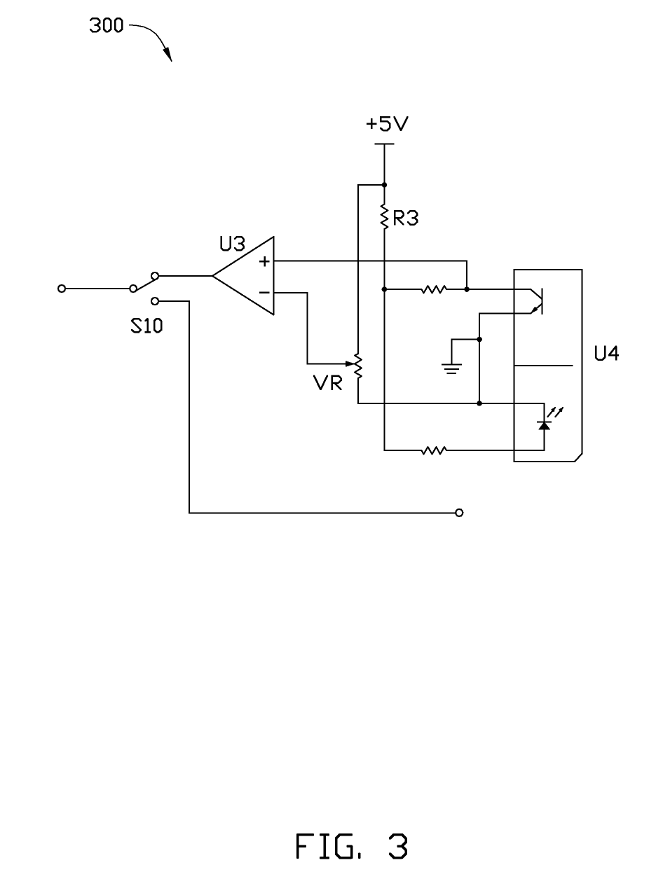

FIG. 3 illustrates a circuit view of the signal collecting module 300, in accordance with one embodiment. The signal collecting module 300 includes a comparator U3, a photocoupler U4, a variable resistor VR, a single-pole double-throw (SPDT) switch S10, and a third resistor R3. The photocoupler U4 includes a switch unit and a light emitting unit. The variable resistor VR includes a first terminal, a second terminal, and an adjusting terminal The SPDT switch S10 includes a first terminal, a second terminal, and a third terminal. A non-inverting input terminal of the comparator U3 is grounded via the switch unit. An inverting input terminal of the comparator U3 is electrically connected to the adjusting terminal of the variable resistor VR. The first terminal of the variable resistor VR receives a third DC voltage. The second terminal of the variable resistor VR is electrically connected to a cathode of the light emitting unit. An anode of the light emitting unit receives the third DC voltage via the third resistor R3. The anode of the light emitting unit is grounded via the switch unit. An output terminal of the comparator U3 is electrically connected to the first terminal of the SPDT switch S10. The second terminal of the SPDT switch S10 is electrically connected to a feedback terminal of the fan 800. The third terminal of the SPDT switch S10 is electrically connected to the rotation information input terminal PB7. In one embodiment, the third DC voltage is +5V.

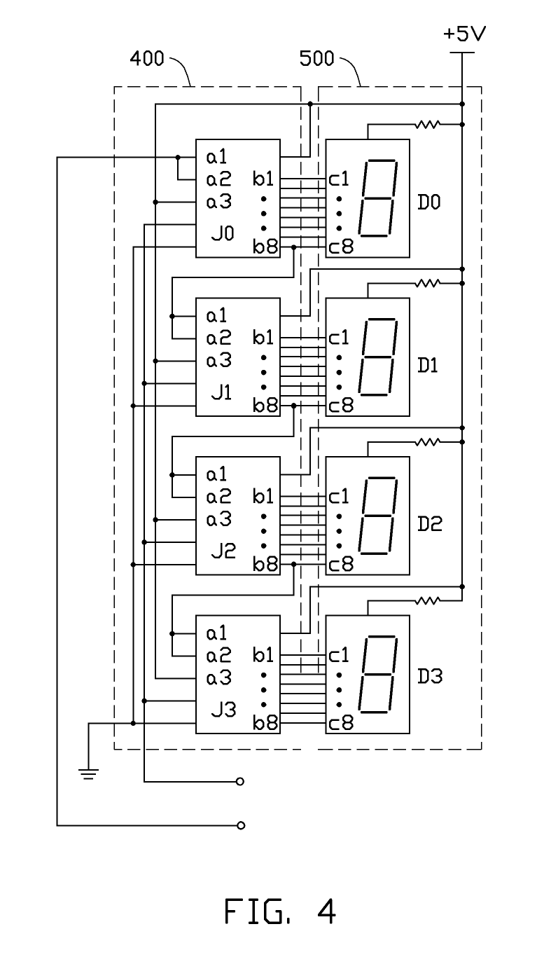

FIG. 4 illustrates a circuit view of the decoding module 400 and the display module 500, in accordance with one embodiment. The decoding module 400 includes a plurality of registers J0-J3. Each of the plurality of registers J0-J3 includes two serial data input terminals a1, a2, a clock signal input terminal a3, and a plurality of digital signal output terminals b1-b8. The serial data input terminals a1, a2 of the register J0 are electrically connected to the serial data output terminal PC0 of the micro controller U1. The serial data input terminals a1, a2 of the register J1 are electrically connected to the digital signal output terminal b8 of the register J0. The serial data input terminals a1, a2 of the register J2 are electrically connected to the digital signal output terminal b8 of the register J1. The serial data input terminals a1, a2 of the register J3 are electrically connected to the digital signal output terminal b8 of the register J2. The clock signal input terminals a3 of the plurality of registers J0-J3 are electrically connected to the clock signal output terminal PC1 of the micro controller U1.

The display module 500 includes a plurality of eight-segment numeral tubes D0-D3. Each of the plurality of eight-segment numeral tubes D0-D3 includes a plurality of digital signal input terminals c1-c8. The plurality of digital signal input terminals c1-c8 of the plurality of eight-segment numeral tubes D0-D3 are electrically connected to the plurality of digital signal output terminals b1-b8 of the plurality of registers J0-J3. In one embodiment, the fan 600 is a linear fan, and the fan 800 is a pulse width modulation (PWM) fan.

In use, the plurality of push buttons S0-S9 are pushed to input the rotation speed signals in the micro controller U1 to set rotation speeds of the fans 600 and 800. The first pulse signal output terminal PD0 and the second pulse signal output terminal PD1 output PWM signals of corresponding duty cycles to the first pulse signal input terminal EN1 and the second pulse signal input terminal EN2 respectively. The first voltage output terminal OUT1 and the second voltage output terminal OUT2 output a corresponding first DC voltage to provide power supply for the fan 600. The third voltage output terminal OUT3 and the fourth voltage output terminal OUT4 output a corresponding first DC voltage to provide power supply for the fan 800. The fans 600 and 800 are driven by the corresponding first DC voltages and rotate under the set rotation speeds. The rotation speed fine tuning input terminal PA3 is used to adjust the rotation speeds of the fans 600 and 800 slightly. In one embodiment, the plurality of push buttons S0-S9 represents numbers 0-9 respectively.

At the meantime, rotation information of the fans 600 and 800 is received the rotation information input terminal PB7. When the micro controller U1 collects the rotation information of the fan 600, the SPDT switch S10 is thrown to connect the first terminal with the third terminal of the SPDT switch S10. A label with an identifiable color is attached on a vane or blade of the fan 600. In one embodiment, the label is white strips and the fan 600 is black. When the fan rotation speed control system is operational, light from the light emitting unit reflects off the label and enables the switch unit to be turned on. At this time, the fan 600 is at a first state. The output terminal of the comparator U3 outputs a low voltage level (i.e., ground) rotation information of the fan 600. The switch unit is turned off if light from the light emitting unit reflects off the other parts of the fan 600. At this time, the fan 600 is at a second state. The output terminal of the comparator U3 outputs a high voltage level (i.e. the second DC voltage or the third DC voltage) rotation information of the fan 600. The label rotates with the vane or blade of the fan 600, thereby the switch unit is turned on intermittently. When the micro controller U1 collects the rotation information of the fan 800, the SPDT switch S10 is thrown to connect the second terminal with the third terminal of the SPDT switch S10. The low voltage level rotation information and the high voltage level rotation information of the fans 600 and 800 are decode to decimal numbers by the plurality of registers J0-J3 which are displayed on the plurality of eight-segment numeral tubes D0-D3.

At the meantime, the first control signal output terminal PA0 and the second control signal output terminal PA1 output high voltage level and low voltage level control signals to the first control signal input terminal IN1, the second control signal input terminal IN2, the third control signal input terminal IN3, and the fourth control signal input terminal IN4 to adjust directions of the first DC voltage. Therefore, rotation directions of the fans 600 and 800 can be changed.

When the first control signal output terminal PA0 outputs the logic 1? voltage level control signal to the first control signal input terminal IN1, the base of the first transistor T1 receives the high voltage level control signal. The first transistor T1 turns on. The collector of the first transistor T1 outputs the logic 0? voltage level control signal to the second control signal input terminal IN2. The first voltage output terminal OUT1 outputs a high voltage level. The second voltage output terminal OUT2 outputs a low voltage level. The fan 600 rotates in a first direction. When the first control signal output terminal PA0 outputs the low voltage level control signal to the first control signal input terminal IN1, the base of the first transistor T1 receives the low voltage level control signal. The first transistor T1 turns off. The collector of the first transistor T1 outputs the high voltage level control signal to the second control signal input terminal IN2. The first voltage output terminal OUT1 outputs a low voltage level. The second voltage output terminal OUT2 outputs a high voltage level. The fan 600 rotates in a second direction, which is opposite to the first direction. In a same way, the micro controller U1 controls the rotation speed controller chip U2 outputs high voltage level and low voltage level at the third voltage output terminal OUT3 and the fourth voltage output terminal OUT4 to adjust directions of the first DC voltage. Therefore, rotation directions of the fan 800 can be changed.

Even though numerous characteristics and advantages of the present disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A fan rotation speed control system for adjusting rotation speed of a fan comprising:
a switch input module adapted to output a rotation speed signal;
a rotation speed control module adapted to receive the rotation speed signal, and to output a first direct current (DC) voltage to provide power supply for the fan accordingly;
wherein the rotation speed control module adjusts values and directions of the first DC voltage according to the rotation speed signal;
a signal collecting module adapted to collect rotation information of the fan; wherein the rotation speed control module receives the rotation information;
a decoding module adapted to decode the rotation information received by rotation speed control module to rotation speed values; and
a display module adapted to display the rotation speed values.

2. The fan rotation speed control system of claim 1, wherein the rotation speed control module comprises a micro controller and a rotation speed controller chip; the micro controller comprises a first pulse signal output terminal and a second pulse signal output terminal; the rotation speed controller chip comprises a first pulse signal input terminal, a second pulse signal input terminal, a first voltage output terminal, and a second voltage output terminal; the first pulse signal output terminal and the second pulse signal output terminal are electrically connected to the first pulse signal input terminal and the second pulse signal input terminal respectively; the micro controller receives the rotation speed signal, and outputs pulse width modulation (PWM) signals at the first pulse signal output terminal and the second pulse signal output terminal accordingly; and the rotation speed controller chip outputs the first DC voltage at the first voltage output terminal and the second voltage output terminal according to the received PWM signals.

3. The fan rotation speed control system of claim 2, wherein the rotation speed control module further comprises a first transistor and a first resistor; the micro controller further comprises a first control signal output terminal; the rotation speed controller chip further comprises a first control signal input terminal and a second control signal input terminal; the first control signal output terminal is electrically connected to the first control signal input terminal; the first control signal output terminal is electrically connected to a base of the first transistor; an emitter of the first transistor is grounded; a collector of the first transistor receives a second DC voltage via the first resistor; and the collector of the first transistor is electrically connected to the second control signal input terminal

4. The fan rotation speed control system of claim 3, wherein the signal collecting module comprises a comparator, a photocoupler, a variable resistor, and a third resistor; the micro controller further comprises a rotation information input terminal; the photocoupler comprises a switch unit and a light emitting unit; the variable resistor comprises a first terminal, a second terminal, and an adjusting terminal; a non-inverting input terminal of the comparator is grounded via the switch unit; an inverting input terminal of the comparator is electrically connected to the adjusting terminal of the variable resistor; the first terminal of the variable resistor receives a third DC voltage; the second terminal of the variable resistor is electrically connected to a cathode of the light emitting unit; an anode of the light emitting unit receives the third voltage via the third resistor; and the anode of the light emitting unit is grounded via the switch unit.

5. The fan rotation speed control system of claim 4, wherein the signal collecting module further comprises a single-pole double-throw (SPDT) switch; the SPDT comprises a first terminal, a second terminal, and a third terminal; the first terminal of the SPDT switch is electrically connected to an output terminal of the comparator; the second terminal of the SPDT switch is electrically connected to a feedback terminal of the fan; and the third terminal of the SPDT switch is electrically connected to the rotation information input terminal.

6. The fan rotation speed control system of claim 5, wherein when the fan is a linear fan, the SPDT switch is threw to connect the first terminal with the third terminal of the SPDT switch; a label with an identifiable color is attached on the fan; when the fan rotation speed control system is operational, light from the light emitting unit reflects off the label and enables the switch unit to be turned on; the output terminal of the comparator outputs a rotation information of the fan at a first state; the switch unit is turned off if light from the light emitting unit reflects off the other parts of the fan; and the output terminal of the comparator outputs a rotation information of the fan at a second state.

7. The fan rotation speed control system of claim 5, wherein when the fan is a PWM fan, the SPDT switch is threw to connect the second terminal with the third terminal of the SPDT switch.

8. The fan rotation speed control system of claim 5, wherein the switch input module comprises a first switch, a second switch, a third switch, and a fourth switch; the micro controller further comprises a first rotation speed input terminal, a second rotation speed input terminal, a third rotation speed input terminal, a fourth rotation speed input terminal, and a fifth rotation speed input terminal; first terminals of the first switch, the second switch, the third switch, and the fourth switch are electrically connected to the first rotation speed input terminal, the second rotation speed input terminal, the third rotation speed input terminal, and the fourth rotation speed input terminal respectively; and second terminals of the first switch, the second switch, the third switch, and the fourth switch are electrically connected to the fifth rotation speed input terminal.

9. The fan rotation speed control system of claim 5, wherein the decoding module comprises a first register, a second register, a third register, and a fourth register; each register comprises two serial data input terminals and a plurality of digital signal output terminals; the serial data input terminals of the first register are electrically connected to the serial data output terminal of the micro controller; the serial data input terminals of the second register are electrically connected to one of the plurality of digital signal output terminals of the first register; the serial data input terminals of the third register are electrically connected to one of the plurality of digital signal output terminals of the second register; and the serial data input terminals of the fourth register are electrically connected to one of the plurality of digital signal output terminals of the third register.

10. The fan rotation speed control system of claim 9, wherein the display module comprises a first numeral tube, a second numeral tube, a third numeral tube, and a fourth numeral tube; each numeral tube comprises a plurality of digital signal input terminals; the plurality of digital signal input terminals of the first numeral tube are electrically connected to the plurality of digital signal output terminals of the first register; the plurality of digital signal input terminals of the second numeral tube are electrically connected to the plurality of digital signal output terminals of the second register; the plurality of digital signal input terminals of the third numeral tube are electrically connected to the plurality of digital signal output terminals of the third register; and the plurality of digital signal input terminals of the fourth numeral tube are electrically connected to the plurality of digital signal output terminals of the fourth register.

11. A fan rotation speed control system for adjusting rotation speed of a fan comprising:
a switch input module adapted to output a rotation speed signal;
a rotation speed control module adapted to receive the rotation speed signal, and output a first direct current (DC) voltage to provide power supply for the fan accordingly; wherein the rotation speed control module comprises a micro controller and a rotation speed controller chip; the micro controller receives the rotation speed signal, and outputs pulse width modulation (PWM) signals accordingly; the rotation speed controller chip outputs the first DC voltage according to the received PWM signals; the rotation speed control module adjusts values and directions of the first DC voltage according to the rotation speed signal;
a signal collecting module adapted to collect rotation information of the fan; wherein the rotation speed control module receives the rotation information;
a decoding module adapted to decode the rotation information received by rotation speed control module to rotation speed values; and
a display module adapted to display the rotation speed values.

12. The fan rotation speed control system of claim 11, wherein the micro controller comprises a first pulse signal output terminal and a second pulse signal output terminal; the rotation speed controller chip comprises a first pulse signal input terminal, a second pulse signal input terminal, a first voltage output terminal, and a second voltage output terminal; the first pulse signal output terminal and the second pulse signal output terminal are electrically connected to the first pulse signal input terminal and the second pulse signal input terminal respectively; the micro controller outputs the PWM signals at the first pulse signal output terminal and the second pulse signal output terminal according to the received rotation speed signal; and the rotation speed controller chip outputs the first DC voltage at the first voltage output terminal and the second voltage output terminal according to the received PWM signals.

13. The fan rotation speed control system of claim 12, wherein the rotation speed control module further comprises a first transistor and a first resistor; the micro controller further comprises a first control signal output terminal; the rotation speed controller chip further comprises a first control signal input terminal and a second control signal input terminal; the first control signal output terminal is electrically connected to the first control signal input terminal; the first control signal output terminal is electrically connected to a base of the first transistor; an emitter of the first transistor is grounded; a collector of the first transistor receives a second DC voltage via the first resistor; and the collector of the first transistor is electrically connected to the second control signal input terminal

14. The fan rotation speed control system of claim 13, wherein the signal collecting module comprises a comparator, a photocoupler, a variable resistor, and a third resistor; the micro controller further comprises a rotation information input terminal; the photocoupler comprises a switch unit and a light emitting unit; the variable resistor comprises a first terminal, a second terminal, and an adjusting terminal; a non-inverting input terminal of the comparator is grounded via the switch unit; an inverting input terminal of the comparator is electrically connected to the adjusting terminal of the variable resistor; the first terminal of the variable resistor receives a third DC voltage; the second terminal of the variable resistor is electrically connected to a cathode of the light emitting unit; an anode of the light emitting unit receives the third voltage via the third resistor; and the anode of the light emitting unit is grounded via the switch unit.

15. The fan rotation speed control system of claim 14, wherein the signal collecting module further comprises a single-pole double-throw (SPDT) switch; the SPDT comprises a first terminal, a second terminal, and a third terminal; the first terminal of the SPDT switch is electrically connected to an output terminal of the comparator; the second terminal of the SPDT switch is electrically connected to a feedback terminal of the fan; and the third terminal of the SPDT switch is electrically connected to the rotation information input terminal.

16. The fan rotation speed control system of claim 15, wherein when the fan is a linear fan, the SPDT switch is threw to connect the first terminal with the third terminal of the SPDT switch; a label with an identifiable color is attached on the fan; when the fan rotation speed control system is operational, light from the light emitting unit reflects off the label and enables the switch unit to be turned on; the output terminal of the comparator outputs a rotation information of the fan at a first state; the switch unit is turned off if light from the light emitting unit reflects off the other parts of the fan; and the output terminal of the comparator outputs a rotation information of the fan at a second state.

17. The fan rotation speed control system of claim 15, wherein when the fan is a PWM fan, the SPDT switch is threw to connect the second terminal with the third terminal of the SPDT switch.

18. The fan rotation speed control system of claim 15, wherein the switch input module comprises a first switch, a second switch, a third switch, and a fourth switch; the micro controller further comprises a first rotation speed input terminal, a second rotation speed input terminal, a third rotation speed input terminal, a fourth rotation speed input terminal, and a fifth rotation speed input terminal; first terminals of the first switch, the second switch, the third switch, and the fourth switch are electrically connected to the first rotation speed input terminal, the second rotation speed input terminal, the third rotation speed input terminal, and the fourth rotation speed input terminal respectively; and second terminals of the first switch, the second switch, the third switch, and the fourth switch are electrically connected to the fifth rotation speed input terminal.

19. The fan rotation speed control system of claim 15, wherein the decoding module comprises a first register, a second register, a third register, and a fourth register; each register comprises two serial data input terminals and a plurality of digital signal output terminals; the serial data input terminals of the first register are electrically connected to the serial data output terminal of the micro controller; the serial data input terminals of the second register are electrically connected to one of the plurality of digital signal output terminals of the first register; the serial data input terminals of the third register are electrically connected to one of the plurality of digital signal output terminals of the second register; and the serial data input terminals of the fourth register are electrically connected to one of the plurality of digital signal output terminals of the third register.

20. The fan rotation speed control system of claim 19, wherein the display module comprises a first numeral tube, a second numeral tube, a third numeral tube, and a fourth numeral tube; each numeral tube comprises a plurality of digital signal input terminals; the plurality of digital signal input terminals of the first numeral tube are electrically connected to the plurality of digital signal output terminals of the first register; the plurality of digital signal input terminals of the second numeral tube are electrically connected to the plurality of digital signal output terminals of the second register; the plurality of digital signal input terminals of the third numeral tube are electrically connected to the plurality of digital signal output terminals of the third register; and the plurality of digital signal input terminals of the fourth numeral tube are electrically connected to the plurality of digital signal output terminals of the fourth register.
